(19) United States
(12) Patent Application Publication
(10) Pub. No.: US 2012/0029983 A1
(43) Pub. Date: Feb. 2, 2012

(54) Conversion Tracking System for an Executable Download

(75) Inventors: Adrian Rodriguez, Bellwood, IL (US); Carl Ludewig, San Rafael, CA (US)

(73) Assignees: Velti USA, Inc., San Francisco, CA (US); Ad Infuse, Inc., San Francisco, CA (US)

(21) Appl. No.: 12/847,751

(22) Filed: Jul. 30, 2010

(51) Int. Cl. G06Q 30/00

(52) U.S. Cl. 705/14.4

(57) ABSTRACT

An example embodiment of the present disclosure provides a conversion tracking system for an executable download on a mobile client device. In the example embodiment, the system stores in memory at least one of a plurality of components of a first notification associated with the presentation of an advertisement for a mobile client application on a client browser of a mobile client device. The example system also stores in memory at least one of a plurality of components of a second notification associated with an activation of the presented advertisement for the mobile client application. In addition, the example system stores in memory at least one of a plurality of components of a third notification associated with the acquisition, installation, and initial launch of the mobile client application and sends a response to the third notification, wherein the acquisition is facilitated by the activated presented advertisement. Notably, the third notification includes a custom uniform resource locator which is operable to subsequently launch the mobile client application. Further, the response to the third notification includes a redirection message operable to launch the mobile client application using the custom uniform resource locator.

### TECHNICAL FIELD

The present disclosure generally relates to the conversion tracking of an executable download on a mobile client device.

### BACKGROUND

The rapidly growing capabilities of mobile devices and networks have created compelling opportunities for content owners, operators, advertisers and technology providers. The deployment of 3G networks, mobile devices with color displays and capable operating systems, as well as the emergence of mobile video networks such as DVB-H, MediaFLO and DMB, offers the possibility of combining the richness of television advertising and the immediacy and directness of mobile with the interactivity and business models of the Internet. The innovations are not limited to the world of mobile phones with significant advances in the capabilities of other mobile devices and related systems, such as personal media players and new content distribution models, such as Podcasting.

Based on the number of mobile devices and their respective users, an advertiser could potentially reach a huge consumer base with targeted or tailored messages. A number of obstacles, however, face the advertiser wishing to capitalize on this opportunity. Given the range and variation of mobile device technologies (such as device types and capabilities, carrier network types and capabilities, and the like) there is a maze of technological barriers that an advertiser must navigate to launch a mobile advertising campaign. For example, the advertiser may have to deal with a number of entities (network operators, content owners, aggregators, etc.), who want to manage the customer relationship and have particular technical requirements and/or policies for ad placement.

In the advertising realm, three stakeholders often work together to deliver advertisements to potential customers. Typically, an owner of a product or service wishes to use an advertisement to generate acquisitions of the product or service by a customer in the form of sales, downloads, or some other desired action. An advertiser coordinates generating advertisements for the product or service. Finally, a publisher presents the advertisement to potential customers on behalf of the advertiser and/or owner. In addition, a fourth stake holder may include mobile carrier networks that support wireless connectivity for mobile devices and may have policies and technical requirements for traffic on their networks.

In general, a conversion tracking system monitors statistics corresponding to advertisements by recording various pieces of information. For example, the owner of a product or service may wish to display an advertisement on a publisher's webpage and track the number of times it is displayed to potential customers, the number of times it is clicked by potential customers, and the number of times it leads to a successful acquisition of the advertised product or service. Not only are these statistics useful in determining the success of an advertising campaign, but also they allow the owner of a product or service to develop a pricing model for compensating publishers and advertisers.

There are three common pricing models in advertising: cost-per-impression, cost-per-click, and cost-per-acquisition. A cost-per-impression refers to the price paid to an advertiser or publisher for a single presentation (impression) of an advertisement to a potential customer. A second pricing model known as a cost-per-click refers to the price paid to an advertiser or publisher for a single click on an advertisement presented to a potential customer. The last common pricing model known as a cost-per-acquisition refers to the price paid to an advertiser or publisher for successful acquisition of a product or service by a potential customer in the form of a sale, download, or some other desired action. Owners can choose between the three pricing models or use some combination of the three models in its advertising campaign.

Thus, it is useful to be able to monitor advertising statistics for the purposes of determining the success of an advertising campaign and developing payment methods for advertisers and publishers. However, tracking advertising statistics on a mobile client device presents various challenges associated with the way the mobile client device operates and acquires executable downloads.

### SUMMARY

In particular embodiments, the present disclosure provides methods, systems, and software directed to a conversion tracking system for an executable download for portable devices, such as smart phones, notebooks, and the like.

In accordance with one embodiment, a method is provided for tracking conversions of a mobile client application at a remote server. In particular embodiments, the method may involve three or more phases. A first phase may involve responding to the receipt of a first notification associated with a presentation of an advertisement for a mobile client application on a client browser of a mobile client device by storing at least one of a plurality of components of the first notification in a memory. Another phase may involve responding to the receipt of a second notification associated with an activation of the presented advertisement for the mobile client application by storing at least one of a plurality of components of the second notification in the memory. Yet another phase may involve responding to the receipt of a third notification associated with an acquisition, installation and initial launch of the mobile client application wherein the acquisition is facilitated by the activated displayed advertisement by storing at least one of a plurality of components of the third notification in the memory and sending a response to the third notification. In particular embodiments, the third notification includes a custom resource locator which is operable to subsequently launch the mobile client application. In certain embodiments, the response to the third notification includes a redirection message operable to launch the mobile client application using the custom uniform resource locator.

Other technical advantages of the present disclosure will be readily apparent to one skilled in the art from the following figures, descriptions, and claims. Moreover, while specific advantages have been enumerated, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which like reference numbers indicate like features, and:

FIG. 1 illustrates a network environment in which embodiments of the present disclosure might operate;

FIG. 2 illustrates an example hardware system for a system server which might be used with some embodiments of the present disclosure;

FIG. 3 illustrates example message flows between various stakeholders in a conversion tracking system for an executable download;

FIG. 4 illustrates a sequential process flow for tracking a presentation of an advertisement for a mobile client application on a client browser of a mobile client device;

FIG. 5 illustrates a sequential process flow for tracking an activation of the presented advertisement for the mobile client application; and

FIG. 6 illustrates a sequential process flow for tracking an acquisition, installation and initial launch of the mobile client application.

### DETAILED DESCRIPTION OF EXAMPLE EMBODIMENTS

The following example embodiments are described and illustrated in conjunction with apparatuses, methods, systems, and software which are meant to be examples and illustrative, not limiting in scope. For example, the network environment set forth below is provided to illustrate how one particular implementation of the present disclosure might be deployed.

### A. Network Environment

As shown by the figures, a scalable system has been developed that supports tracking conversions corresponding to advertisements and other promotional messages directed to executable applications for installation on a mobile client device.

In general, a device on a network such as the Internet is delivered advertising content across the network with the intervention of publishers and advertising networks. Publishers typically represent the entity controlling the delivery of content specifically requested by the user. For example, a user may make a request for a particular webpage such as one of many news websites or Internet search engines. In addition to delivering the user-requested content, these websites also deliver embedded advertisements. Thus, in the advertising context, a Publisher delivers embedded advertisements along with user-requested content. However, Publishers typically do not determine which advertisements to deliver on their own. Instead, Publishers typically depend on Advertising Networks to determine the appropriate advertisements and to track various advertising statistics related to the delivered advertisements. Frequently, the determination of which advertisements to deliver will be based on various marketing statistics such as user demographics, thereby facilitating the delivery of targeted advertising to the user. Advertising statistics tracked by the Advertising Network may include but are not limited to the presentation, activation, and acquisition associated with a delivered advertisement. Such advertising statistics can be used to determine the success of an advertising campaign. In addition, those same advertising statistics provide the metering necessary to accurately develop payment schemes for various stakeholders involved in the delivery of advertising content.

Often, stakeholders other than the Advertising Networks have a desire to independently track advertising statistics corresponding to the delivery of advertisements to a user via the Advertising Network and the Publisher. To facilitate independent tracking, Trackers provide advertising monitoring services which mirror the tracking of advertising statistics by the Advertising Network. As a result, although performed independently, Trackers maintain some of the same advertising statistics tabulated by the Advertising Network including, for example, the presentation, activation, and acquisition associated with a delivered advertisement.

With the proliferation of mobile client devices and their increasing ability to manage web content, advertisers and other advertising stakeholders now look to these mobile client devices as a new platform for delivering advertisements. Many mobile client devices acquire functionality through mobile client applications designed specifically to operate on such devices. To promote use of the mobile client applications, Application Vendors may have to advertise the availability of such mobile client applications as being available for download. As can be expected, with the desire to deliver such advertisements on mobile client devices comes technological complexities associated with managing advertising statistics for the delivered advertisements. In addition, further complexities arise when tracking advertisements statistics associated with advertisements for mobile client applications available through an Application Vendor. As the figures illustrate, the present disclosure is directed to overcoming these complexities.

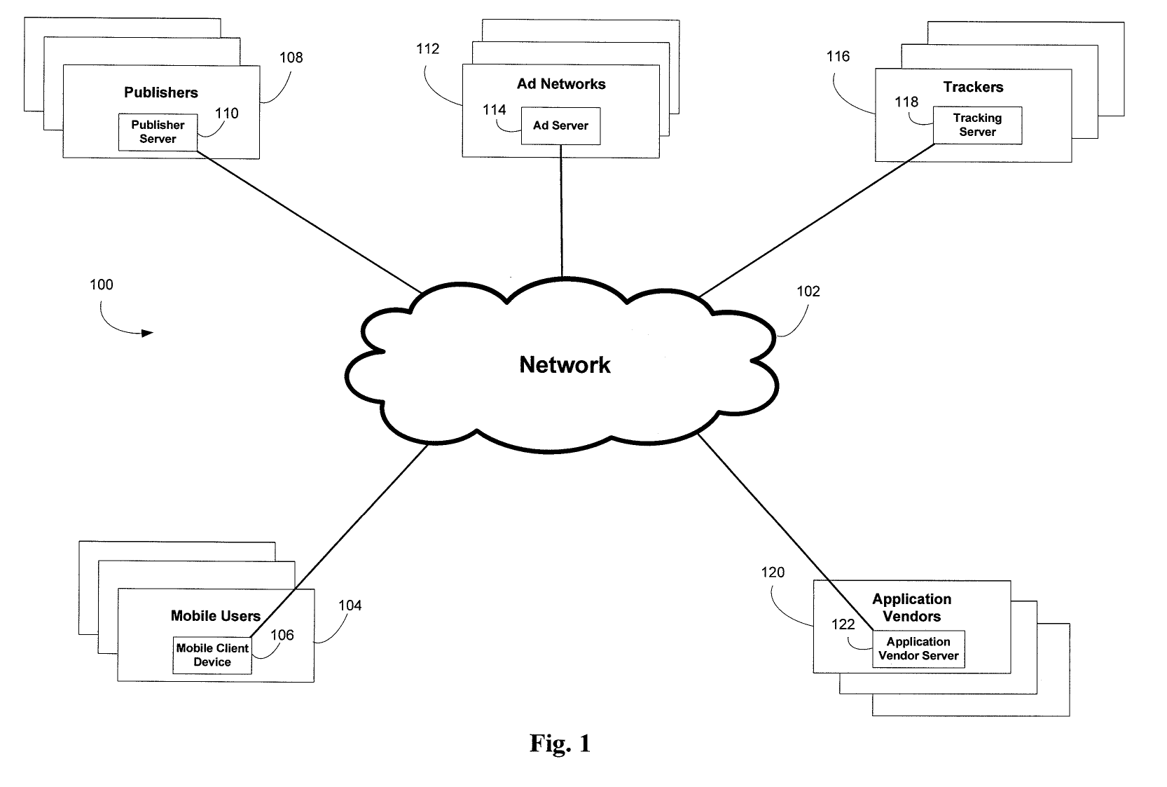

FIG. 1 illustrates an example network environment 100 in which embodiments of the present disclosure might operate. Network 102 of network environment 100 permits communication between various devices and servers responsible for facilitating the tracking of mobile client application conversions, which in one embodiment involves a user downloading an executable application to a mobile device and installing such executable application. In particular embodiments, network 102 may be a wireless, cellular and/or packet-based data network.

As FIG. 1 illustrates, a plurality mobile users 104 may be functionally linked to the network 102, each through a mobile client device 106. Mobile client device 106 can be any suitable mobile or portable electronic or computing device. Typically, a mobile client device 106 includes one or more processors, a memory, a display and a user interface. The mobile client device 106 further includes one or more mechanisms allowing for the exchange of data, such as a wireless network interface, a Bluetooth interface, a serial port, a Universal Serial Bus adapter, and the like. Examples of mobile devices are cellular telephones, wireless email devices, handheld gaming devices, personal digital assistants, and multimedia players (such as the iPod offered by Apple Computer Inc. of Cupertino, Calif.). The mobile client device 106 may incorporate an operating system which manages and controls the operation of its various hardware components, including the input and output of data to and from software applications. The operating system provides an interface between the software applications being executed on the mobile client device and the hardware components of the mobile client device. According to one embodiment of the present disclosure, the operating system is a mobile operating system such as the iPhone OS for the iPhone offered by Apple Computer Inc of Cupertino, Calif. However, the mobile client device may use any number of other suitable operating systems providing substantially similar functionality. Using their respective mobile client device 106, the mobile users 104 may communicate to various other entities also linked to the network 102.

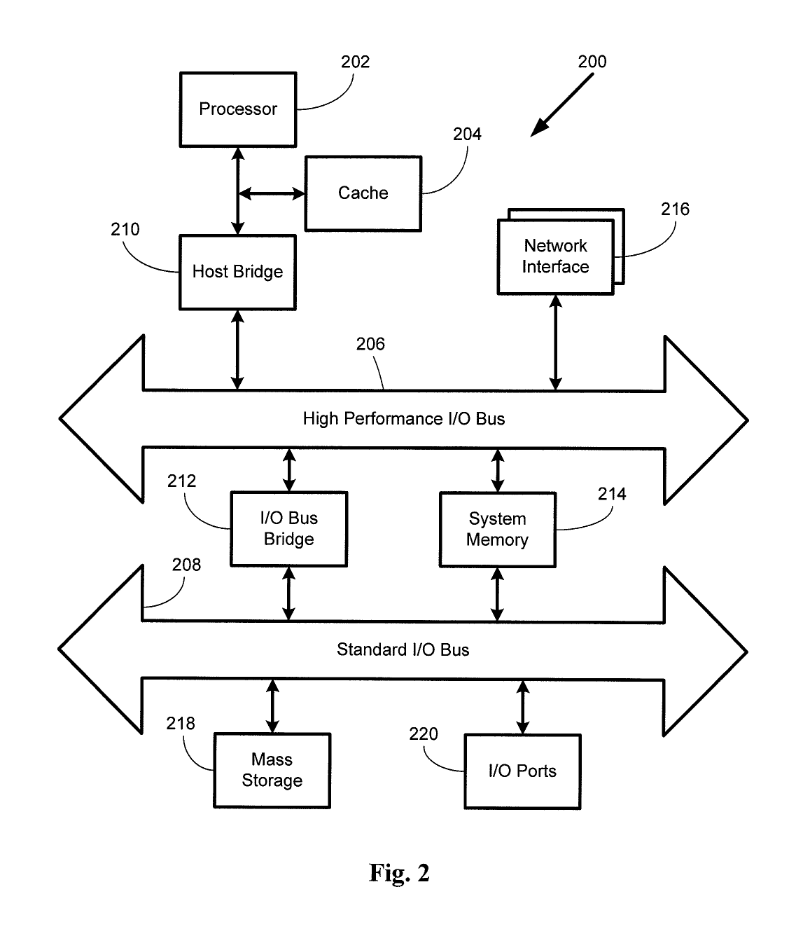

In addition, example network 102 may be linked to publishers 108 via their respective publisher server 110. In particular embodiments, a user may request access via the mobile client device 106 across network 102 to content available from publishers 108 through their respective publisher server 110. For example, a user may seek the retrieval of a webpage from one of many publishers 108 by invoking a request for that webpage through a client browser of the mobile client device 106 to the publisher server 110. Moreover, publisher server 110 may be embodied in a server having various hardware components such as those illustrated in the example hardware system for a system server of FIG. 2.

Likewise, advertising networks (“ad networks”) 112 may also be functionally linked to network 102 and upon request deliver advertisements through their respective advertising server (“ad server”) 114 to entities such as publishers 108. In addition, advertising server 114 is operable to track advertising statistics associated with a delivered advertisements. Ad server 114 may be embodied in a server having various hardware components such as those illustrated in the example hardware system for a system server of FIG. 2.

Similarly, trackers 116 may be functionally linked to the network 102 to independently track statistics associated with advertisements delivered by ad networks 112, using a tracking server 118. Like the publisher server 110 and ad server 114, tracking server 118 may also be embodied in a server having various hardware components such as those illustrated in the example hardware system for a system server of FIG. 2.

A number of application vendors 120 may be functionally linked to network 102 to facilitate acquisition of a mobile client application through their respective application vendor server 122. In particular embodiments, a user may request, across network 102, the download of a mobile client application from one of many application vendors 120 through its application vendor server 122. This would be accomplished by initiating a download request for that mobile client application from an interface available on the mobile client device 106 facilitating access to the appropriate application vendor server 122. The application vendor server 122 may be embodied in a server having various hardware components such as those illustrated in the example hardware system for a system server of FIG. 2.

### B. Example Hardware System for a System Server

FIG. 2 illustrates, for didactic purposes, an example hardware system 200, which might be used as a server which runs all or part of an conversion tracking system, in some embodiments of the present disclosure. In one embodiment, hardware system 200 includes a processor 202, a cache memory 204, and one or more software applications and drivers directed to the functions described herein. Additionally, hardware system 200 includes a high performance input/output (I/O) bus 206 and a standard I/O bus 208. A host bridge 210 couples processor 202 to high performance I/O bus 206, whereas I/O bus bridge 212 couples the two buses 206 and 208 to each other. A system memory 214 and a network/communication interface 216 couple to bus 206. Hardware system 200 may further include video memory (not shown) and a display device coupled to the video memory. Mass storage 218 and I/O ports 220 couple to bus 208. In one embodiment, hardware system 200 may also include a keyboard and pointing device 222 and a display 224 coupled to bus 208. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 200 are described in greater detail below. In particular, network interface 216 provides communication between hardware system 200 and any of a wide range of networks, such as an Ethernet (e.g., IEEE 802.3) network. Mass storage 218 provides permanent storage for the data and programming instructions to perform the functions described herein, whereas system memory 214 (e.g., DRAM) provides temporary storage for the data and programming instructions when executed by processor 202. I/O ports 220 are one or more serial and/or parallel communication ports that provide communication between additional peripheral devices, which may be coupled to hardware system 200.

Hardware system 200 may include a variety of system architectures; and various components of hardware system 200 may be rearranged. For example, cache 204 may be on-chip with processor 202. Alternatively, cache 204 and processor 202 may be packed together as a “processor module,” with processor 202 being referred to as the “processor core.” Furthermore, certain embodiments of the present disclosure may not require nor include all of the above components. For example, the peripheral devices shown coupled to standard I/O bus 208 may couple to high performance I/O bus 206. In addition, in some embodiments only a single bus may exist with the components of hardware system 200 being coupled to the single bus. Furthermore, hardware system 200 may include additional components, such as additional processors, storage devices, or memories.

In particular embodiments, the conversion tracking system, as well as other computer-implemented operations described herein includes a series of software routines run by hardware system 200. These software routines include a plurality or series of instructions to be executed by a processor in a hardware system, such as processor 202. Initially, the series of instructions are stored on a storage device, such as mass storage 218. However, the series of instructions can be stored on any suitable storage medium, such as a diskette, CD-ROM, ROM, or EEPROM. Furthermore, the series of instructions need not be stored locally, and could be received from a remote storage device, such as a server on a network, via network/communication interface 216. The instructions are copied from the storage device, such as mass storage 218, into memory 214 and then accessed and executed by processor 202.

An operating system manages and controls the operation of hardware system 200, including the input and output of data to and from software applications (not shown). The operating system provides an interface between the software applications being executed on the system and the hardware components of the system. According to one embodiment of the present disclosure, the operating system is the LINUX operating system. However, embodiments of the present disclosure may be used with other suitable operating systems, such as the Windows® 95/98/NT/XP/Vista/7 operating system, available from Microsoft Corporation of Redmond, Wash., the Apple Macintosh Operating System, available from Apple Computer Inc. of Cupertino, Calif., UNIX operating systems, and the like.

### C. Processes for Tracking the Conversion of an Advertised Executable Download

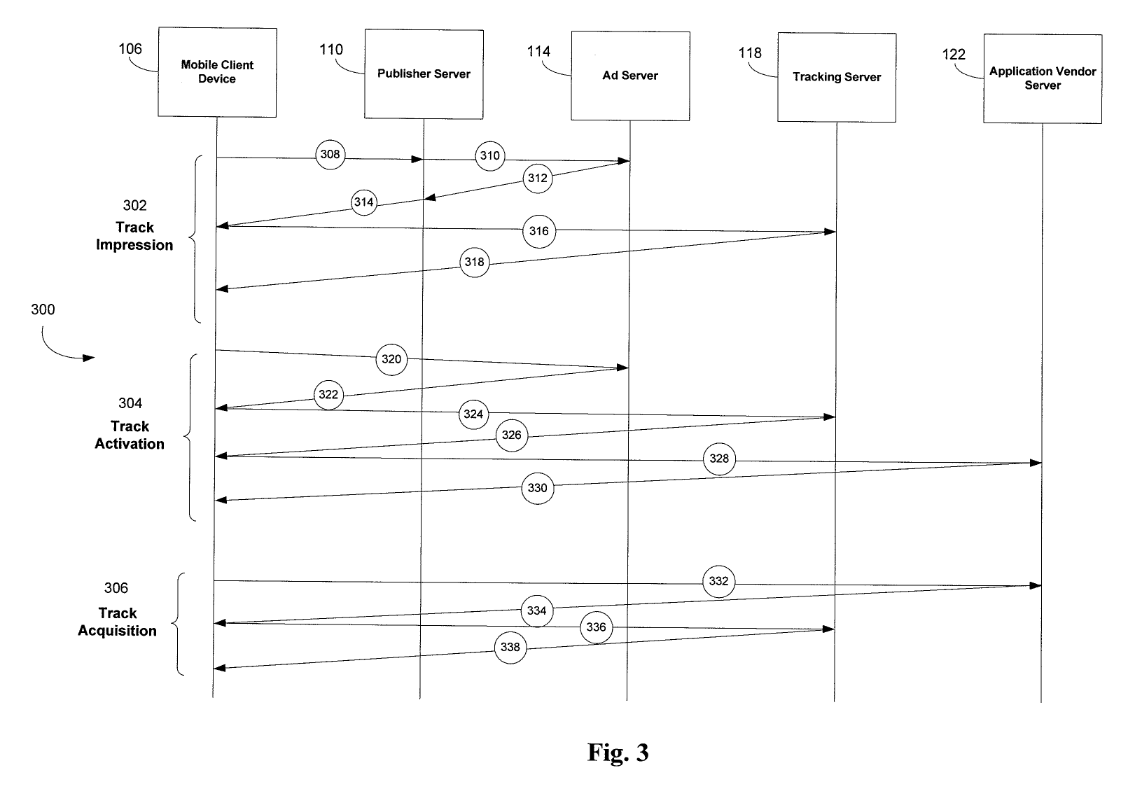

FIG. 3 illustrates message flows 300 between various stakeholders in a conversion tracking system for an executable download advertised to one or more mobile users, which might be employed by some embodiments of the present disclosure. Example message flows 300 illustrates three sets of message flows associated with the conversion tracking of an advertised mobile client application. More specifically, the three sets of message flows 302, 304, and 306 which relate to tracking an ad presentation (impression), activation, and acquisition corresponding to an advertisement for a mobile client application.

1. Process for Tracking an Ad Impression

Among other things, FIG. 3 demonstrates a tracking impression message flow 302 for tracking the presentation (or impression) of an advertisement for a mobile client application. Relevant portions of FIG. 3 demonstrate that, in particular embodiments, mobile client device 106 may transmit a request message 308 for content, which is forwarded to the appropriate publisher server 110 for processing. In response to the request for content, the publisher server 110 first transmits a request message 310 to ad server 114 for an advertisement. In response to request message 310, ad server 114 determines a particular advertisement to deliver to the mobile client device 106. In another implementation, publisher server 110 transmits a structured document or other content to mobile client device 106 that includes an embedded reference to the ad server 114. When processed by the mobile client device 106, the embedded reference causes the client application hosted by mobile client device 106 to transmit a request for an ad directly to ad server 114. In certain embodiments determining a particular advertisement may involve employing marketing statistics to select a targeted advertisement. In addition, ad server 114 tracks various advertising statistics including statistics associated with the impending presentation of the advertisement to a mobile client device 106. Next, upon receipt of a particular advertisement via response message 312, the publisher server 110 issues a response message 314 with the requested content and the advertisement acquired from ad server 114. In certain embodiments, the advertisement delivered to the mobile client device may include a tracking mechanism associated with tracking server 118, such as a tracking pixel, to permit the independent tracking of advertising statistics associated with the presentation of the advertisement.

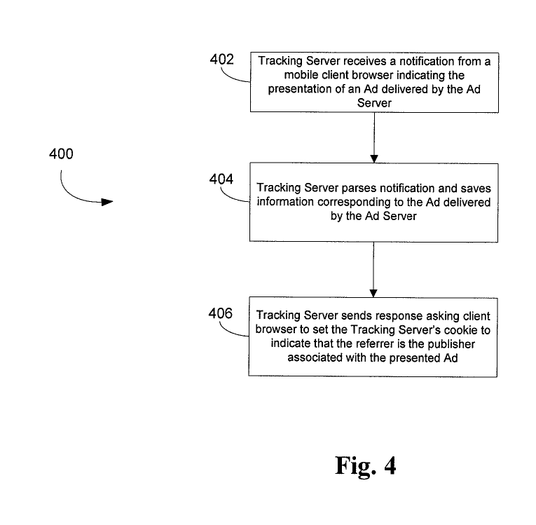

Next, mobile client device 106, upon processing the tracking pixel embedded in the ad, triggers the tracking mechanism (in some implementations, the transmission of a request message to tracking server 118) thereby notifying the tracking server 118 that a presentation of a particular advertisement has taken place via notification message 316. Tracking server 118, like ad server 114, tracks various advertising statistics including statistics associated with the presentation of the advertisement to the mobile client device 106. Finally, tracking server 118 may respond to the notification message 316 with a response message 318 to mobile client device 106. In one implementation, tracking server 118 may set a browser cookie or other state object that is appended to the response message and stored on mobile client device 106. For didactic purposes, FIG. 4 illustrates in further detail the nature of these messages.

As FIG. 4 illustrates, in particular embodiments, the process for tracking a presentation of an advertisement 400 begins at step 402, where tracking server 118 receives a notification from a client browser of mobile client device 106 indicating the presentation of an advertisement delivered by the ad server 114. The notification transmitted by mobile client device 106 may include an advertisement identifier, a campaign identifier, a user identifier (e.g., an anonymous user identifier or other identifier used for correlating messages in other phases, and other meta data desired for purposes of tracking) At step 404, tracking server 118 parses the notification and saves information corresponding to the advertisement by the ad server 114. For example, the tracking server 118 may store the advertisement identifier, the time of delivery, the user agent of the mobile client device 106, the publisher (referrer), and a generated session identifier that will be used for subsequent tracking events. Ultimately at step 406, tracking server 118 sends a response message 318 requesting that the client browser of the mobile client device 106 update the unique cookie for tracking server 118 to indicate that the referrer is the publisher associated with the presented advertisement.

2. Process for Tracking an Activation

Among other things, FIG. 3 demonstrates a tracking activation message flow 304 for tracking the activation of an advertisement for a mobile client application. In one embodiment, activating an advertisement for a mobile client application may include clicking on the advertisement. Relevant portions of FIG. 3 demonstrate that, in particular embodiments, mobile client device 106 may transmit a request message 320 for content associated with an activated advertisement, which is forwarded to the appropriate ad server 114 for processing. In response to the request for content, the ad server 114 tracks various advertising statistics including statistics associated with the activation of the advertisement at mobile client device 106. Next, the ad server 114 transmits a response message 322 which, in certain embodiments, may include a tracking mechanism associated with tracking server 118, such as a tracking pixel, to permit the independent tracking of advertising statistics associated with the activation of the advertisement.

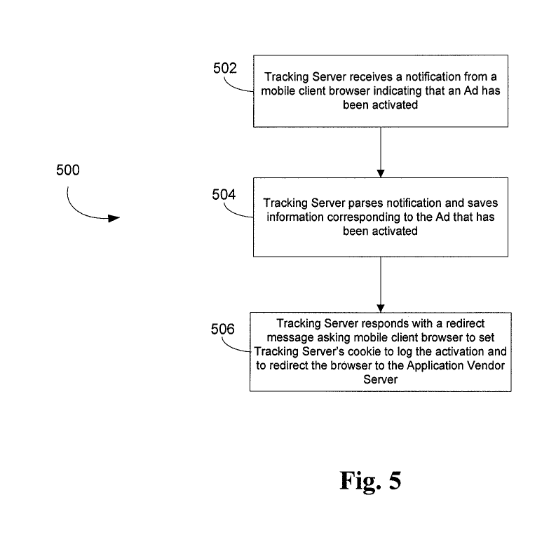

Next, mobile client device 106 triggers the tracking mechanism thereby notifying the tracking server 118 that an activation of a particular advertisement has taken place via notification message 324. Tracking server 118, like ad server 114, tracks various advertising statistics including statistics associated with the activation of the advertisement by the mobile client device 106. Finally, tracking server 118 responds to the notification message 324 with a response message 326 to mobile client device 106. FIG. 5 illustrates in further detail the nature of these messages.

As FIG. 5 illustrates, in particular embodiments, the process for tracking an activation of an advertisement 500 begins at step 502, wherein tracking server 118 receives a notification from a client browser of mobile client device 106 indicating the activation of a presented advertisement originally delivered by the ad server 114. At step 504, tracking server 118 parses the notification and saves information corresponding to the activated advertisement originally delivered by the ad server 114. For example, the tracking server 118 may store the advertisement identifier, the time of activation, the user agent of the mobile client device 106, the publisher (referrer), and the previously generated session identifier. Ultimately at step 506, tracking server 118 sends a response message 326 requesting, among other things, that the client browser update the state information of the cookie for tracking server 118 to indicate that the advertisement has been clicked. In addition, the response message 326 includes a redirection request redirecting the client browser of mobile client device 106 to the application vendor server 122. Once the redirection message is triggered in request message 328, the application vendor server 122 presents an interface to download or otherwise acquire the relevant mobile client application on mobile client device 106 via response message 330.

3. Process for Tracking an Acquisition

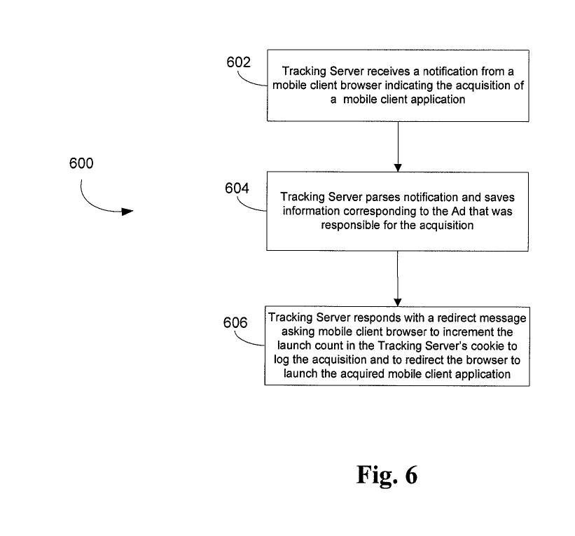

Among other things, FIG. 3 demonstrates a tracking acquisition message flow 306 for tracking the acquisition of a mobile client application corresponding to an activated displayed advertisement. In one embodiment, acquiring the mobile client application may include downloading the mobile client application. Relevant portions of FIG. 3 demonstrate that, in particular embodiments, mobile client device 106 may transmit a request message 332 for acquiring a mobile client application, which is forwarded to the appropriate application vendor server 122 for processing. In response to the request, the application vendor server 122 delivers a response comprising one or more messages 334 which includes an installable mobile client application. Once the mobile client application is installed at mobile client device 106 and launched for the first time, the mobile client application causes the transmission of a notification message 336 to tracking server 118 via a client browser of the mobile client device 106. For example, in one implementation, the newly downloaded mobile client application includes computer program code which, upon first execution or initialization of the downloaded client application, causes the mobile client browser hosted on mobile client device to launch and transmit a request for tracking server 118. In one implementation, the entity that provides the tracking server may publish a set of application programming interfaces and libraries that assist application developers to create downloadable client applications to utilize this functionality for the tracking-related purposes described herein. The tracking server 118, in turn, tracks various advertising statistics including statistics associated with the advertisement leading to the acquisition, installation, and initial launch of the mobile client application at mobile client device 106. Finally, tracking server 118 responds to the notification message 336 with a response message 338 to mobile client device 106. FIG. 6 illustrates in further detail the nature of these messages.

As FIG. 6 illustrates, in particular embodiments, the process for tracking an acquisition of a mobile client application 600 begins at step 602, wherein tracking server 118 receives a notification message 336 from a client browser of mobile client device 106 indicating the acquisition, installation and initial launch of the mobile client application associated with the advertisement originally delivered by the ad server 114. In certain embodiments, the notification message 336 may include a custom uniform resource locator. A custom uniform resource locator is a reference the mobile client application registered with the operating system of the mobile client device 106. More specifically, the custom uniform resource locator is operable, when processed by a mobile browser hosted on mobile client device 106, to launch the mobile client application at some later point in time. At step 604, tracking server 118 parses the notification message 336 (including state information in an appended cookie) and saves information associated with the advertisement originally delivered by ad server 114 and leading to the acquisition, installation and initial launch of the mobile client application at mobile client device 106. For example, the tracking server 118 may store the advertisement identifier that caused the acquisition (if any), the previously generated session identifier, the rating of the mobile client application, the price of the mobile client application, the date that the mobile client application was posted on the application vendor server 122, the version of the mobile client application, the publisher (referrer), the user's unique identifier for the mobile client application, and the user agent of the mobile client device 106. In addition, the tracking server may store the number of times the mobile client application has been launched, which could facilitate tracking the acquisition if tracking failed on previous launches. Ultimately at step 606, tracking server 118 sends a response message 338 requesting, among other things, that the client browser update the unique cookie for tracking server 118 to indicate that an acquisition has occurred. For example, the tracking server 118 may request that the launch count in the unique cookie for tracking server 118 be incremented. The mobile client device 106 may also store an acknowledgement indicating that the acquisition was successfully tracked. Maintaining such acknowledgement data prevents the tracking of the same acquisition again on a subsequent launch. In certain embodiments, the response message 338 includes a redirection request redirecting the client browser of mobile client device 106 to launch the mobile client application using the custom uniform resource locator, originally found in the notification message 336. As a result of processing the uniform resource locator, the mobile client application launches the mobile client application again. This redirection scheme ensures that the conversion tracking is minimally intrusive to the user by allowing the mobile client application of mobile client device 106 to launch for the first time, load a client browser of the mobile client device 106 for the brief period of time necessary to track the acquisition, and then immediately launch the mobile client application again for the user. Thus, this redirection scheme facilitates minimally intrusive conversion tracking by a seamless context switch from the mobile client application to the client browser and back to the mobile client application. In other words, the process may occur automatically without further action by a user of mobile client device 106.

Particular embodiments of the conversion tracking system might be comprised of instructions that are stored on a storage media. The instructions might be retrieved and executed by a processing system. The instructions are operational when executed by the processing system to direct the processing system to operate in accordance with the present disclosure. Some examples of instructions are software, program code, firmware, and microcode. Some examples of storage media are memory devices, tape, disks, integrated circuits, and servers. The term “processing system” refers to a single processing device or a group of inter-operational processing devices. Some examples of processing devices are integrated circuits and logic circuitry. Those skilled in the art are familiar with instructions, storage media, and processing systems.

Those skilled in the art will appreciate variations of the above-described embodiment that fall within the scope of the present disclosure. It will be appreciated that in this regard, there are many other possible arrangements of the advertising entities and servers that still implement the functionality described herein. Further, it will be appreciated that there are many other possible message flows which might implement the communications necessary to track conversions. As a result, the present disclosure is not limited to the specific examples and illustrations discussed above.

What is claimed is:

1. A method for tracking conversions of a mobile client application, comprising:
in response to receiving a first notification associated with a presentation of an advertisement for a mobile client application on a client browser of a mobile client device, storing at least one of a plurality of components of the first notification in a memory;
in response to receiving a second notification associated with an activation of the presented advertisement for the mobile client application, storing at least one of a plurality of components of the second notification in the memory; and
in response to receiving a third notification associated with an acquisition, an installation and an initial launch of the mobile client application, wherein the third notification comprises a custom uniform resource locator operable to subsequently launch the mobile client application and the acquisition is facilitated by the activated presented advertisement:
storing at least one of a plurality of components of the third notification in the memory; and
sending a response to the third notification, the response comprising an acquisition redirection message operable to launch the mobile client application using the custom uniform resource locator.

2. The method of claim 1 wherein the first notification, the second notification, and the third notification are associated with each other in a tracking data in the memory.

3. The method of claim 2, wherein the first notification, the second notification, and the third notification comprise:
an advertisement identifier associated with the advertisement for the mobile client application;
an advertisement campaign identifier associated with the advertisement for the mobile client application;
an application name associated with the mobile client application;
an application version associated with a version of the client application; and
the tracking data, the tracking data further comprising:
a session identifier for uniquely associating the first notification, the second notification, and the third notification;
a publisher identifier associated with a publisher of the advertisement for the mobile client application;
an activation counter associated with the activation of the presented advertisement; and
an acquisition counter associated with the acquisition of a version of the client application.

4. The method of claim 3, wherein:
the step of responding to receiving a first notification further comprises sending a first message to the client browser, the first message comprising a request to update the publisher identifier of the tracking data with the publisher of the presented advertisement;
the step of responding to receiving a second notification further comprises sending a second message to the client browser, the second message comprising a request to increment the activation counter of the tracking data and an activation redirection message; and
the step of responding to receiving a third notification further comprises sending a third message to the client browser, the third message comprising a request to increment the acquisition counter of the tracking data and the acquisition redirection message.

5. The method of claim 4, wherein:
the activation redirection message of the second message is associated with a uniform resource locator of an application vendor server operable to facilitate the acquisition of the mobile client application; and
the acquisition redirection message of the third message is associated with the custom uniform resource locator of the mobile client application.

6. A system for tracking conversions of a mobile client application, comprising:
a memory;
one or more processors operable when executed to:
in response to receiving a first notification associated with a presentation of an advertisement for a mobile client application on a client browser of a mobile client device, storing at least one of a plurality of components of the first notification in the memory;
in response to receiving a second notification associated with an activation of the presented advertisement for the mobile client application, storing at least one of a plurality of components of the second notification in the memory; and
in response to receiving a third notification associated with an acquisition, an installation and an initial launch of the mobile client application, wherein the third notification comprises a custom uniform resource locator operable to subsequently launch the mobile client application and the acquisition is facilitated by the activated presented advertisement:
storing at least one of a plurality of components of the third notification in the memory; and
sending a response to the third notification, the response comprising an acquisition redirection message operable to launch the mobile client application using the custom uniform resource locator.

7. The method of claim 2 wherein the first notification, the second notification, and the third notification are associated with each other in a tracking data in the memory.

8. The system of claim 7, wherein the first notification, the second notification, and the third notification comprise:
an advertisement identifier associated with the advertisement for the mobile client application;
an advertisement campaign identifier associated with the advertisement for the mobile client application;
an application name associated with the mobile client application;
an application version associated with a version of the client application; and
the tracking data, the tracking data further comprising:
a session identifier for uniquely associating the first notification, the second notification, and the third notification;
a publisher identifier associated with a publisher of the advertisement for the mobile client application;
an activation counter associated with the activation of the presented advertisement; and
an acquisition counter associated with the acquisition of a version of the client application.

9. The system of claim 8, wherein:
responding to receiving a first notification further comprises sending a first message to the client browser, the first message comprising a request to update the publisher identifier of the tracking data with the publisher of the presented advertisement;
responding to receiving a second notification further comprises sending a second message to the client browser, the second message comprising a request to increment the activation counter of the tracking data and an activation redirection message; and
responding to receiving a third notification further comprises sending a third message to the client browser, the third message comprising a request to increment the acquisition counter of the tracking data and the acquisition redirection message.

10. The system of claim 9, wherein:
the activation redirection message of the second message is associated with a uniform resource locator of an application vendor server operable to facilitate the acquisition of the mobile client application; and
the acquisition redirection message of the third message is associated with the custom uniform resource locator of the mobile client application.

11. A non-transitory computer readable medium comprising computer executable instructions operable when executed to:
in response to receiving a first notification associated with a presentation of an advertisement for a mobile client application on a client browser of a mobile client device, storing at least one of a plurality of components of the first notification in a memory;
in response to receiving a second notification associated with an activation of the presented advertisement for the mobile client application, storing at least one of a plurality of components of the second notification in the memory; and
in response to receiving a third notification associated with an acquisition, an installation and an initial launch of the mobile client application, wherein the third notification comprises a custom uniform resource locator operable to subsequently launch the mobile client application and the acquisition is facilitated by the activated presented advertisement:
storing at least one of a plurality of components of the third notification in the memory; and
sending a response to the third notification, the response comprising an acquisition redirection message operable to launch the mobile client application using the custom uniform resource locator.

12. The non-transitory computer-readable medium of claim 11 wherein the first notification, the second notification, and the third notification are associated with each other in a tracking data in the memory.

13. The non-transitory computer-readable medium of claim 12, wherein the first notification, the second notification, and the third notification comprise:
an advertisement identifier associated with the advertisement for the mobile client application;
an advertisement campaign identifier associated with the advertisement for the mobile client application;
an application name associated with the mobile client application;
an application version associated with a version of the client application; and
the tracking data, the tracking data further comprising:
a session identifier for uniquely associating the first notification, the second notification, and the third notification;
a publisher identifier associated with a publisher of the advertisement for the mobile client application;
an activation counter associated with the activation of the presented advertisement; and
an acquisition counter associated with the acquisition of a version of the client application.

14. The non-transitory computer-readable medium of claim 13, wherein:
the step of responding to receiving a first notification further comprises sending a first message to the client browser, the first message comprising a request to update the publisher identifier of the tracking data with the publisher of the presented advertisement;
the step of responding to receiving a second notification further comprises sending a second message to the client browser, the second message comprising a request to increment the activation counter of the tracking data and an activation redirection message; and
the step of responding to receiving a third notification further comprises sending a third message to the client browser, the third message comprising a request to increment the acquisition counter of the tracking data and the acquisition redirection message.

15. The non-transitory computer-readable medium of claim 14, wherein:
the activation redirection message of the second message is associated with a uniform resource locator of an application vendor server operable to facilitate the acquisition of the mobile client application; and
the acquisition redirection message of the third message is associated with the custom uniform resource locator of the mobile client application.
